(19) United States
(12) Patent Application Publication
(10) Pub. No.: US 2023/0010072 A1
(43) Pub. Date: Jan. 12, 2023

(54) STEM FOR A BICYCLE WITH ELASTOMER DAMPING

(71) Applicant: Marzell MAIER, Isny (DE)

(72) Inventor: Marzell MAIER, Isny (DE)

(21) Appl. No.: 17/811,930

(22) Filed: Jul. 12, 2022

(30) Foreign Application Priority Data
Jul. 12, 2021 (DE) 10 2021 117 980.7

(51) Int. Cl. B62K 21/14; B62K 19/32

(52) U.S. Cl. CPC B62K 21/14; B62K 19/32; B62K 2201/02

(57) ABSTRACT

A sprung stem for bicycles, in particular for racing bicycles and gravel bikes, for the sprung connection between the handlebar and the head tube and/or the steerer tube with improved damping is proposed, wherein a coupling apparatus for mechanical coupling of the connecting parts is provided, which coupling apparatus comprises at least one elastomer body which is mounted in such a way that it is deformed during pivoting of the static fastening device with respect to the handlebar holder, in order thus to absorb force and to damp the relative movement between the handlebar and the head tube.

### FIELD OF THE INVENTION

The present invention relates to a sprung stem for bicycles, as can be used, in particular, in the case of racing bicycles and gravel bikes.

### BACKGROUND OF THE INVENTION

A bicycle stem which is formed by way of two arms which are guided in parallel is known from the prior art, for example, from WO 2013/033674 A1. The arms are fastened in each case via rotary joints to fixed points toward the head tube and the handlebar, with the result that these pivot points form a parallelogram. The intrinsic pivoting movement of the stem is braked by way of a spring.

### SUMMARY OF THE INVENTION

It is an object of the present invention to propose a stem for bicycles, in particular, for racing bicycles and gravel bikes, which stem makes improved damping possible.

The sprung stem according to the present invention is particularly suitable for racing bicycles and gravel bikes. The stem connects the handlebar to the head tube and/or the fork. In the case of riding off-road or over uneven routes, the front wheel is subject to abrupt jolts. These jolts load the wrists very heavily, without sufficient damping, because the impacts are transmitted via the fork or the head tube directly to the hands or wrists.

The present invention is distinguished by the fact that elastomer bodies are used in order to implement a damping action. It has been recognized here that, although the rings which are otherwise often conventionally used in the prior art can absorb the jolt, they ideally output the energy again virtually completely. Therefore, springs tend to be unsuitable as damping elements in the actual sense, since the year absorbed energy is only buffer-stored, but is not dissipated or is not substantially dissipated.

### Advantages of a Negative Spring Travel (Sag):

In particular, the present invention makes it possible for what is known as a negative spring travel (sag) to be provided. The springs which have been used up to now can be subjected, above all, to a compression load. In the case of off-road riding, the head tube and/or the fork can be moved fundamentally in the two directions (toward the track or in the opposite direction). This is because, in the case of greatly uneven terrain, the jolts which are forwarded via the fork exclusively to the hands of the rider or to the wrists can occur in the two directions, toward the ground and in the opposite direction, perpendicularly in the direction of the track or vice versa. If, in accordance with the prior art, conventional springs are used, the cyclist then perceives the mechanical stops in the limit regions of the springs: if, for example, the front wheel strikes the ground, the mass which is formed by way of the handlebar and the cyclist supported by way of his/her hands thereon is moved in the direction of the ground and is then braked; the spring is compressed until it forms a mechanical stop in the case of its maximum possible compression, with the result that a jolt is transmitted to the handlebar in the hands. The travel as far as this point is called a positive spring travel. As a result of the elastic spring effect, rebound which can have an unpleasant effect on the hands usually subsequently occurs in the opposite direction.

If, conversely, the spring is subjected to a tensile load, a conventional spring in accordance with the prior art can usually scarcely extend, since a spring which can be subjected to a compressive and a tensile load is not used. A corresponding negative spring travel does not exist in practice, with the result that a mechanical stop can be perceived directly in the hands.

In accordance with the present invention, however, damping with a positive spring travel (in the case of an action of force in the direction of the track) and with a negative spring travel (in the case of an action of force in the opposite direction) is instead advantageously provided, and a harsh riding sensation as a consequence of a hard stop is avoided.

The present invention, therefore, makes it possible to utilize a series of advantages in comparison with the previous prior art, by way of the provision of the negative spring travel:

A conventional suspension fork does not have this negative spring travel without loading, in contrast to the present invention.

As a result of the static weight distribution, what is known as sag as a result of the existing mass is present without preloading by way of jolts. The weight primarily loads the saddle and the pedal crank.

This sag is usually not present in this way in the case of a sprung stem, in contrast to the suspension fork, since the rider of the bicycle supports himself/herself with a small amount of force via the handlebar.

The introduction of force via the handlebar rises only in the case of certain riding situations, for example, in the case of braking.

It is, therefore, advantageous to already provide a construction with sag from a standstill, as is possible according to the present invention.

A contribution to the improvement in the riding sensation is also made by the fact that the stem according to the present invention has a parallelogram-like construction and the absorbing movement does not, as is customary in the case of some conventional stems in accordance with the prior art, have a single pivot point, about which the stem is tilted. The sides of the parallelogram remain constantly parallel, even when the stem absorbs a jolt and the handlebar moves relative to the fork or to the head tube. This leads to a situation where, although the handlebar is displaced with regard to its position with respect to the fork or with respect to the head tube in the case of the parallelogram construction, the handlebar is not turned or tilted in the case of the absorbing compensation movement of the stem. Tilting of this type would have the disadvantage that the hands or wrists would also be tilted together with the handlebar and would, therefore, be loaded in a more pronounced manner, precisely even when, in the case of off-road riding, jolts on the fork, head tube, handlebar and wrists are fundamentally to be expected.

There is at the same time according to the present invention the advantage of the capability for retrofitting. As an alternative option to the sprung stem, there is also the option of using a suspension fork, with the result that, as it were, the front wheel is directly spring-mounted. A suspension fork of this type cannot be readily retrofitted, however, unlike a sprung stem. A sprung stem, therefore, proves to be particularly advantageous in the case of what are known as gravel bikes which are fundamentally derived from racing bicycles, but are intended to facilitate riding on gravel roads, but also do not have to be configured for pure off-road rides of the highest possible load level.

The fork-side or head tube-side part of the stem is configured as a static fastening device, the term “static” relating to the fact that the fastening device does not change its position with respect to the main part of the bicycle, the frame. The static fastening device is fastened fixedly to the fork, or more precisely to the head tube or the steerer tube.

In contrast, the free end of the stem forms or opens into a handlebar holder for connecting the stem to the handlebar.

The suspension apparatus of the stem is situated between the handlebar holder and the static fastening apparatus. It serves to mechanically couple the handlebar holder and the static fastening apparatus, which mechanical coupling is to be designed in such a way that jolts on the front wheel or the fork are to be absorbed with respect to the handlebar. The suspension apparatus form two parallel sides of the parallelogram which has already been mentioned above. It is, therefore, split in two and comprises two arms which are guided in parallel and act as connecting parts in each case between the static fastening apparatus and the handlebar holder. Each connecting part is mounted on the static fastening apparatus and on the handlebar holder such that it can be pivoted about a pivot pin. The pivot pins run in parallel. The pivot pins run horizontally with respect to the ground in the case of an upright bicycle.

The two other sides of the parallelogram are situated in each case in the region of the static fastening apparatus or the handlebar holder. The spacing of the two pivot pins on the static fastening apparatus is constant. The position of these pivot pins with respect to one another is also not changed when the stem makes an absorbing suspension movement. The spacing of the two pivot pins on the handlebar holder is likewise also constant, and their relative position is also not changed with respect to one another when the stem makes an absorbing suspension movement. Relative positions of the static fastening apparatus and the handlebar holder with respect to one another generally change, however, during the absorbing suspension movement by the stem, that is to say the two sides of the parallelogram along the connecting parts can be pivoted in each case with respect to the head tube-side or handlebar-side parallelogram side.

The pivoting movement of the connecting parts is damped by virtue of the fact that the connecting parts are also additionally coupled to one another mechanically. This coupling apparatus comprises at least one elastomer body which brings about firstly the coupling and secondly the damping action. The elastomer body is deformed reversibly in the case of the action of a force from the outside. This deformation reverts back when the action of force is canceled again. However, energy is also used up during the deformation, that is to say there is not a purely elastic effect, in the case of which the entire energy is spontaneously output again. The action of force takes place by way of the connecting parts or arms which in each case carry out a pivoting movement. The at least one elastomer body is mounted in such a way that it is deformed in the process. For example, in the non-deflected state of the stem, the elastomer body is configured and mounted in such a way that at least one side wall bears against one of the connecting parts and is inserted, for example, in a substantially positively locking manner between the connecting parts.

In the case of one advantageous embodiment of the present invention, the connecting parts themselves are therefore of initially rigid configuration, that is to say are made from metal or hard, stable plastic, glass fiber-reinforced plastic or the like. In order for it to be possible for the elastomer body or bodies to be mounted in such a way that they are deformed in the case of a pivoting movement of the stem, it is advantageous in the case of one development of the present invention for the connecting parts to be configured as shells, with the result that the elastomer body is mounted therein. The shape of the shell can advantageously be adapted to the shape of the elastomer body, with the result that the pivoting movement leads directly to the deformation of the elastomer body. The shell can also ensure secure and positionally stable retention of the elastomer body. For this reason, it can be appropriate for the shells of the connecting parts to be arranged so as to lie opposite one another and so as to point toward one another, with the result that the elastomer body or elastomer bodies can be received in between.

Moreover, the shell shape ensures secure retention of the elastomer body, since the elastomer body can bear by way of its end side against the bottom of the shell and can be supported laterally by way of the wall. This provides secure retention, despite the movements of the stem, in the case of which movements, above all, the parallelogram shape (here, the included angles), within which the elastomer body is mounted, changes. At the same time, the elastomer body can be replaced simply and inexpensively. It is merely necessary for the elastomer body to be removed from the shells and a new one to be inserted. This is because the elastomer body can be held between the shells freely without adhesive bonding or another integrally joined connection. In addition, the use of composite materials, in particular, of elastomer bodies in a sandwich design, is not necessary.

It is fundamentally sufficient to use one elastomer body. A plurality of elastomer bodies can also be used for improved adjustability, however. They can be arranged connected in series in the connecting line between the stationary fastening element and the handlebar holder. The constituent parts of the elastomer body are displaced in the case of a deformation. The mechanical resistance which occurs in the case of the deformation is, therefore, also dependent on whether there is space, into which the constituent parts can be displaced. Therefore, for example, the resistance can also be changed by the fact that, instead of one elastomer body, two elastomer bodies are placed in series, the width of which is smaller, however, than that of the single elastomer body, and they are arranged in such a way that a gap or a spacing is produced between them. As a result, the resistance is decreased somewhat.

In order that the spacing or the gap remains constant and the elastomer bodies do not slip, a spacer element can be arranged between them. The spacer element can also exercise further functions, however:

By way of adjustment of the position of the spacer element, for example, the mechanical resistance in the case of a deformation can be set.

In this regard, the spacer element can be set in a variable manner in the case of one advantageous development of the present invention, with the result that the bicycle rider can individually set the suspension of the stem.

The spacer element can be configured in such a way that it still leaves a gap between the elastomer bodies, or the spacer element is configured as a continuous solid body which cannot be deformed and which therefore further increases the resistance between the elastomer bodies.

In the case of one design variant, the spacer element can also be of wedge-shaped configuration. The further it is pushed into the region between the elastomer bodies, the wider it becomes and the more the elastomer bodies are already compressed by way of the spacer element, with the result that the mechanical resistance increases. For example, two wedge-shaped elements can be arranged pointing toward one another with their wedge point. If they are spaced apart further from one another, the mechanical resistance is smaller. The closer they are to one another, the more the spacer elements overlap the elastomer body. In the case of a deformation, this elastomer body has less space, and the resistance rises. As a result of the wedge shape, however, the elastomer body is possibly also compressed by way of the wedge, which can additionally increase the resistance.

The wedges can have a thread which engages into another thread, for example, that of a threaded rod or a setting screw, with the result that the wedge is displaced by way of adjustment of the thread.

Furthermore, elastomer bodies can also be arranged connected in parallel in relation to an imaginary line between the static fastening element and the handlebar holder. This also facilitates the arrangement of the spacer elements in relation to a thread axis which mounts them, because a more flexible construction is possible. The setting screw for mounting the spacer elements can be arranged, for example, in the center of four elastomer bodies.

A gap can exist between the elastomer bodies, which gap is closed more and more by way of displacement of the spacer elements, in order to increase the mechanical resistance. It is also conceivable, however, that gaps are cut out or machined in an elastomer body itself, in order to decrease or to set the resistance. This affords the advantage during manufacturing that different stems can be constructed with different resistances, it merely being necessary for different elastomer bodies to be used for the different degrees of hardness.

The spacer element can have an X-shape in cross section along a plane which runs parallel to the pivot pins, in a similar manner to an hourglass (two wedges which face one another with their points). As a result, the resistance can be changed disproportionately in a manner which is dependent on how father spacer elements have been pulled toward the center of the elastomer bodies.

The head tube and the handlebar lie perpendicularly with respect to one another, or are as a rule displaced with respect to one another by way of the stem in such a way that they form two crooked straight lines.

As has already been shown, the present invention makes a positive and negative spring travel possible. The spring travel cannot be of unlimited magnitude, however, and there is a mechanical constraint in the case of the pivoting movement. In this respect, a stop element is advantageously provided in the case of one embodiment of the present invention, which stop element can be configured, for example, as an elastomer, in order that the movement and the freedom of movement are clearly defined.

In order to realize a compact construction, the stop element can be arranged between the two pivot pins on the static fastening element and/or between the two pivot pins on the handlebar holder.

In the case of one development of the mention, it is sufficient for a single contiguous elastomer body to be provided which is so large that the sides of the described parallelogram, through the corner points of which the pivot pins run, penetrate the elastomer body. The advantage of this development consists in that the stem can comprise fewer parts, and a single elastomer body can be installed and replaced more simply.

In addition, the elastomer body can be configured as a closed ring. In order to set the degree of hardness of the stem, it can therefore be sufficient to introduce or to remove a hard core into/from the recess which is produced in this way, with the result that the overall structure of the elastomer body becomes correspondingly harder or softer, depending on how far into the elastomer body this core is situated. As a core, for example, a spring stiffness pin can be introduced into or at least partially removed from this recess, with the result that the elastomer body can be deformed and compressed to a greater or lesser extent. By virtue of the fact that the ring is of closed configuration, the spring stiffness pin cannot be pushed out of the ring in the case of mechanical loads, in particular, shear movements of the parallelogram.

The recess can be of slot-shaped configuration, with the result that, even in the case of a narrow shape, the spring stiffness pin fills the recess in such a way that the elastomer body can be deformed only to a restricted degree. In addition, an anti-rotation safeguard can be produced by way of the seat within the recess, in order that the spring stiffness pin does not co-rotate when the adjusting spindle is rotated.

If, in the case of one embodiment of the present invention, the connecting parts are configured as shells, the single elastomer body can be gripped by the two shells which lie opposite one another, and can be mounted securely in the stem, in the case of the shear movements of this stem which are to be expected, without slipping.

With regard to its extent in the unloaded state along the connecting line between the fastening apparatus and the handlebar holder, the elastomer body is smaller than transversely with respect to this direction. In the case of a positive or negative spring travel, a shear movement of the elastomer body therefore occurs rather than a compression. As a result, the damping action can be improved in an advantageous way. In addition, a greater spring travel can be provided geometrically than in the case of mere squeezing of the elastomer body.

Apart from that, the base height, at which the handlebar is situated, and/or the angle which the coupling apparatus encloses with the fork or the head tube can also be influenced by way of the shape of the elastomer body. In the case of one design variant of the present invention, the elastomer body is of stepped configuration on its outer shell. Overall, it can be of axially symmetrical configuration with regard to an axis of symmetry. With regard to its envelope, the elastomer body resembles, for example, two cuboids which are displaced with respect to one another. If the perpendiculars to the respective sides of the parallelogram are considered, the elastomer body is accordingly not mirror-symmetrical. This measure additionally makes it possible that the elastomer body is adapted to the positive and negative spring travel by way of its shape, since the corresponding sections of the elastomer body are arranged offset diagonally around the central pivot pin of the stem, and the elastomer body is adapted rather to the shape of a parallelogram. In the case of another development, the elastomer body can also have the shape of a parallelogram (instead of the stepped shape), in particular, of a parallelogram which:

has a similar size in relation to edge length and area to the parallelogram which is formed from the pivot pins, and/or

is arranged rotated with respect to the parallelogram which is formed from the pivot pins.

### BRIEF DESCRIPTION OF THE DRAWINGS

Exemplary embodiments of the present invention are shown in the drawings and will be described in greater detail in the following text with the specification of further details and advantages.

FIG. 1 shows a diagrammatic illustration of a stem in accordance with the present invention, the upper connecting part being hidden;

FIG. 2 shows an illustration of the complete stem from FIG. 1;

FIG. 3 shows a sectional illustration along the longitudinal extent of the stem from FIG. 1; and

FIG. 4 shows a diagrammatic illustration of the coupling apparatus with elastomer bodies and spacer elements (exploded illustration); and, furthermore:

FIG. 5 shows a diagrammatic illustration of a part of the coupling apparatus for one exemplary embodiment with only one contiguous elastomer body;

FIGS. 6, 7 show the positioning of the spring stiffness pin in the case of the setting of the degree of hardness of the coupling apparatus; and

FIG. 8 shows a diagrammatic illustration of a stem with a coupling apparatus according to FIG. 5 (section).

### DETAILED DESCRIPTION OF THE INVENTION

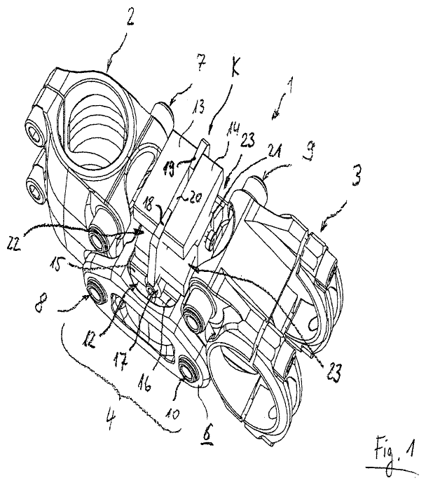

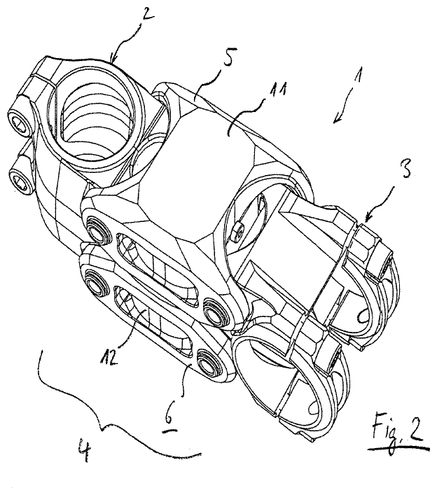

FIG. 1 shows a sprung stem 1 with a static fastening device 2 which can engage around the steerer tube or the head tube, a handlebar holder 3 which in turn can engage around the handlebar, and with a suspension apparatus 4 which connects the fastening device 2 to the handlebar holder 3. The suspension apparatus 4 comprises two connecting parts 5, 6 (cf. also FIG. 2). FIG. 1 shows only the lower connecting part 6. Two pivot pins 7, 8 are situated on the fastening device to, just as two pivot pins 9, 10 are arranged on the handlebar holder 3. Each connecting part 5, 6 is mounted pivotably via the pivot pins 7, 9 and 8, 10 on the one side on the fastening device 2 and on the other side on the handlebar holder. The connecting lines of the pivot pins 7 to the pivot pin 9 to the pivot pin 10 to the pivot pin 8 and back again to the pivot pins 7 form a parallelogram.

Shells 11, 12 are machined in the connecting parts. The shells 11, 12 are arranged with their openings toward one another. Each shall 11 and 12 receives in each case two elastomer bodies 13, 14 and 15, 16, respectively. Therefore, the two elastomer bodies 13, 14 and 15, 16 are in each case arranged in series, whereas the elastomer bodies 13, 15 and 14, 16 are arranged parallel to one another.

A setting screw 17 is provided transversely through the center of this foursome arrangement of elastomer bodies 13, 14, 15, 16, on the thread axis of which setting screw 17 wedge-shaped spacer elements 18, 19 are screwed in or mounted. By way of rotation of the setting screw 17, the wedges 18, 19 are pushed closer together or moved further apart from one another. In FIG. 1, the spacer elements 18, 19 are continued below the setting screw 17, that is to say spacer elements 18, 19 are not only arranged between the elastomer bodies 13, 14 but also between the elastomer bodies 15, 16. They are analogously wedge-shaped. The gap 20 is reduced in size when the wedges (spacer elements) 18, 19 are pushed together.

The elastomer bodies 21 are additionally held by way of a fixing means 21.

As viewed along a connecting axis between the static fastening apparatus 2 and the handlebar holder 3, the elastomer bodies 13, 14, 15, 16 have approximately an X-shape or, more precisely, the shape of an hourglass, that is to say recesses 22, 23 are present in the lateral regions.

If the front wheel experiences a jolt, for instance in the case of off-road riding, this jolt is transmitted via the fork or the head tube to the fastening device and via the suspension apparatus for toward the handlebar holder 3. On account of the inertia of the handlebar and the rider supported thereon, the suspension apparatus 4 is pivoted, and the handlebar moves relative to the head tube. On account of the parallelogram construction of the stem, however, the handlebar is not rotated about its own longitudinal axis, and the hands of the rider are not rotated, but rather remain in their orientation.

By virtue of the fact that the elastomer bodies 13, 14, 15, 16 are received substantially without play in the shells 11, 12, they are deformed in the case of pivoting of the connecting parts 5, 6. The material can yield partially into the gaps 20, 22, 23. The closer the spacer wedges 18, 19 are moved together, the smaller the gap 20 becomes. Moreover, the elastomer bodies 13, 14 are compressed on account of the wedge shape. The mechanical resistance becomes greater during the suspension movement.

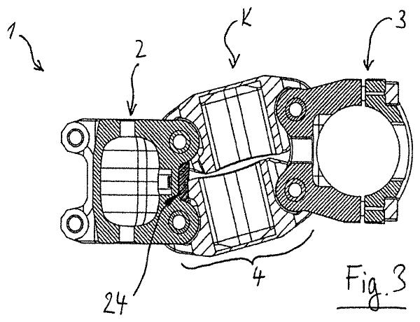

Stop elements 24 in the form of elastomers are introduced centrally in each case between the pivot pins 7, 8 and between the pivot pins 9, 10. During pivoting, the connecting parts 5, 6 can come into contact there if the deflection becomes too great (cf. FIG. 3).

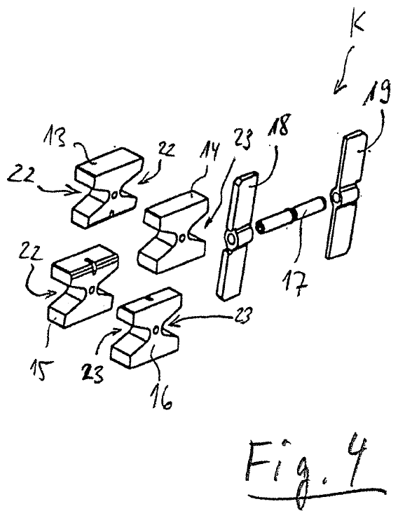

FIG. 4 shows the elastomer bodies 13, 14, 15, 16 which, as viewed laterally, have a type of “X-shape” or the shape of an “hourglass”, in order to set the mechanical resistance during the deformation. The resistance is increased disproportionately by way of the shape which tapers toward the center, the closer the spacer elements 18, 19 approach the center of the elastomer bodies 13, 14, 15, 16, since the gaps 22, 23 are reduced in size greatly here toward the center and more elastomer body has to be deformed. By way of rotation of the setting screw 17, the spacer elements 18, 19 which are of wing-like configuration are displaced with their wedge-shaped wings along the setting screw and are thus moved closer to the center of the elastomer bodies 13, 14, 15, 16 or further away from the center of 13, 14, 15, 16. The closer to the center they are situated, the higher the mechanical resistance, since the elastomer bodies 13, 14, 15, 16 are already pre-compressed and the space for yielding of the elastomer bodies 13, 14, 15, 16 likewise shrinks. The elastomer bodies 13, 14, 15, 16 and the spacer elements 18, 19 which are mounted via the setting screw 17 form the essential parts of the coupling apparatus K.

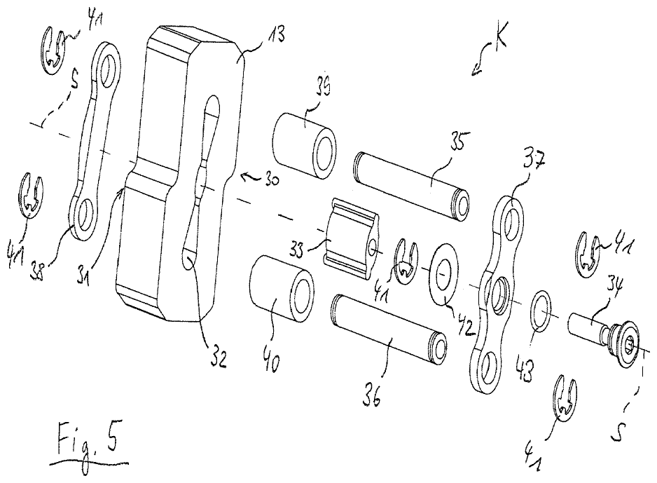

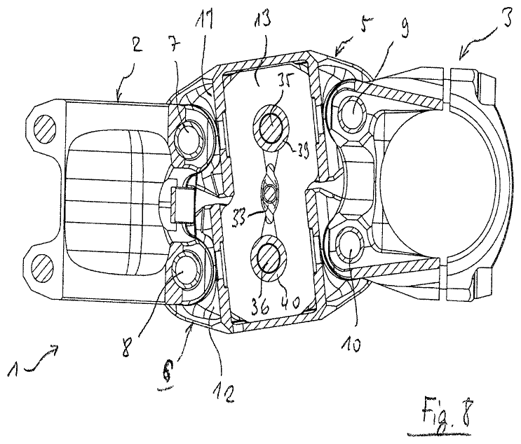

FIG. 5 diagrammatically shows the construction of a part of the coupling apparatus K with a single, contiguous elastomer body 13 with a closed ring shape. The elastomer body 13 is axially symmetrical in relation to the axis of symmetry S which is shown. The outer shell of the elastomer body 13 has two steps 30, 31 which lie diagonally opposite one another in relation to the axis of symmetry S. In a manner which corresponds to its annular structure, the elastomer body 13 has a through bore or recess 32 which passes through the body and is of slot-shaped configuration, that is to say extends considerably further in the longitudinal direction than transversely with respect thereto. The orientation of the slot 32 approximately follows the course direction of the steps 30, 31. This step-like construction of the elastomer body 13 ensures that the center of the fastening device 2 and the handlebar holder 3 are displaced with respect to one another. The height of the handlebar is displaced (in this regard, see also FIG. 8).

The spring stiffness pin 33 which is arranged on the middle mounting shaft which coincides with the axis of symmetry S has a substantially oval cross section. The recess in the elastomer body 13, through which the middle mounting shaft runs, is slot-shaped and, as a result, is configured such that the spring stiffness pin 33 bears against the inner walls of the recess 32, and the further it is introduced into the recess 32, the more its deformation capability decreases. As a consequence, the hardness of the coupling apparatus K can be set by the depth to which the spring stiffness pin 33 is introduced into the elastomer body 13, that is to say by how much the spring stiffness pin 33 co-defines the deformation properties of the elastomer body 13. In order for it to be possible for the spring stiffness pin 33 to be displaced along the middle longitudinal axis or axis of symmetry S, it is mounted on an adjusting spindle 34. The adjusting spindle 34 has an external thread which engages into an internal thread of the spring stiffness pin 33. Since the spring stiffness pin 33 is mounted at least partially in the slot-shaped recess 32 of the elastomer body 13, it is sufficient to prevent a rotation of the spring stiffness pin 33, that is to say the pin 33 can be moved in a linear manner by way of the adjusting spindle 34 as a result of this non-rotational mounting, that is to say can be introduced to a greater or lesser extent into the elastomer body 13. When it is introduced completely into the elastomer body 13, the spring stiffness pin 33 forms a hard core which makes the overall structure of the coupling apparatus K seem harder with respect to deformations and/or shear movements.

The adjusting spindle 34 and the mounting shafts 35, 36 are held via the two connecting webs 37, 38 in a defined position with respect to the elastomer body 13.

As can be seen in FIG. 5, the shafts 35, 36 are surrounded each case by a spacer sleeve 39, 40, in order to obtain improved retention in the elastomer body 13 as a result of the increased diameters. In order to mount the shafts 35, 36 and the adjusting spindle 34 rotatably on the web 37, 38, clips 41 are provided. In addition, washers 42 can be used for improved mounting. In order that the adjusting spindle 34 also remains in this set position during the adjustment, a self-locking means is necessary. To this end, an O-ring 43 (sealing ring) bears against the adjusting spindle 34.

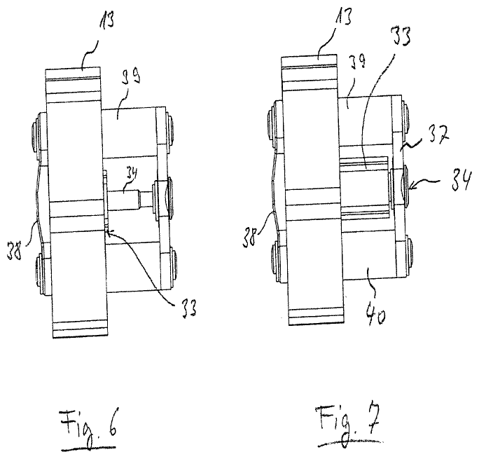

FIGS. 6 and 7 in turn show a side view of this part of the coupling apparatus K, namely the elastomer body 13 which is penetrated by the mounting shafts 35, 36. An adjusting spindle 34 is arranged in the region of the middle mounting axis, on the thread of which adjusting spindle 34 the spring stiffness pin 33 is seated. The spring stiffness pin 33 dips at least partially into the elastomer body 13, more precisely into the recess 32 in the elastomer body 13. The mounting shafts 35, 36 are arranged via two connecting webs 37, 38, in each case one in front of and one behind the elastomer body 13. The adjusting spindle 34 which is also held by one of the connecting webs 37 is situated on the middle mounting axis or the axis of symmetry S. In the case of hard setting (FIG. 6), the spring stiffness pin 33 dips further into the elastomer body 13 than in the case of soft setting (FIG. 7).

FIG. 8 shows a section through a stem with a coupling apparatus or an elastomer body 13 in accordance with the exemplary embodiment according to FIG. 5. The fastening apparatus 2 engages around the head tube or the fork. As a result of the stepped shape of the elastomer body 13, the coupling apparatus K is tilted slightly with respect to a horizontally running line in FIG. 8, with the result that, in contrast, the handlebar holder 13 is offset upward somewhat.

### LIST OF REFERENCE SIGNS

1 Stem
2 Static fastening device
3 Handlebar holder
4 Suspension apparatus
5 Connecting part
6 Connecting part
7 Pivot pin
8 Pivot pin
9 Pivot pin
10 Pivot pin
11 Shell
12 Shell
13 Elastomer body
14 Elastomer body
15 Elastomer body
16 Elastomer body
17 Setting screw
18 Spacer element
19 Spacer element
20 Gap
22 Gap
23 Gap
24 Stop element
30 Step
31 Step
32 Recess
33 Spring stiffness pin
34 Adjusting spindle
35 Mounting shaft
36 Mounting shaft
37 Connecting shaft
38 Connecting shaft
39 Sleeve
40 Sleeve
41 Clip
42 Washer
43 O-ring (sealing ring)
K Coupling apparatus
S Axis of symmetry

1. A sprung stem for bicycles for the sprung connection between the handlebar and the head tube and/or the steerer tube, comprising:
a static fastening device for fastening the stem to the head tube and/or the steerer tube,
a handlebar holder for connecting the stem to the handlebar,
a suspension apparatus for suspending the handlebar and for mechanical coupling between the static fastening device and the handlebar holder,
wherein the suspension apparatus is split at least in two and comprises two connecting parts which both in each case connect the fastening apparatus and the handlebar holder,
wherein the suspension apparatus is mounted via two pivot pins on the static fastening device and via two pivot pins on the handlebar holder,
wherein the connecting parts are connected rotatably firstly in each case via one of the pivot pins to the fastening apparatus and secondly via another one of the pivot pins to the handlebar holder, with the result that the spacing between the two pivot pins which are connected to one another by way of the same connecting part is constant, and/or the side lengths of a parallelogram which is formed are constant,
wherein the pivot pins run parallel to one another and are arranged in such a way that the pivot pins penetrate a plane perpendicularly with respect to the pivot pins in such a way that the penetration points configure the corner points of the parallelogram, and
wherein a coupling apparatus is provided for mechanical coupling of the connecting parts, which coupling apparatus comprises at least one elastomer body which is mounted in such a way that it is deformed during pivoting of the static fastening device with respect to the handlebar holder, in order thus to absorb force and to damp the relative movement between the handlebar and the head tube.

2. The sprung stem according to claim 1, wherein the connecting parts:
are in each case of rigid configuration, and/or
are configured in each case as shells, and the at least one elastomer body is mounted at least partially therein,
wherein the shells of two of the connecting parts are oriented so as to in each case face one another, with the result that the elastomer body or the elastomer bodies is/are mounted between the connecting parts in the shells, preferably without an integrally joined connection between elastomer body and the respective shell,
wherein the shells in each case have a bottom and a wall, wherein the elastomer body bears with an end side against the bottom, and wherein the wall laterally covers the elastomer body which is mounted therein, in order to prevent lateral slipping of the elastomer body.

3. The sprung stem according to claim 1, wherein the coupling apparatus has at least two elastomer bodies which are connected in series in a connecting line between the fastening device and the handlebar holder, wherein a spacer element is arranged between the at least two elastomer bodies which are connected in series, in order to set the spacing and/or the coupling and/or the play between the at least two elastomer bodies which are connected in series, wherein the spacer element is of wedge-shaped configuration and being arranged in such a way that it performs the setting operation by way of displacement.

4. The sprung stem according to claim 3, wherein the spacer element comprises two wedge-shaped spacer elements, the points of which point toward one another, and which spacer elements are connected to one another by way of a setting screw, with the result that the spacing between the spacer elements can be set by way of rotation of the setting screw.

5. The sprung stem according to claim 1, wherein two elastomer bodies which are connected in series are arranged along each of the connecting parts.

6. The sprung stem according to claim 1, wherein in each case two elastomer bodies are arranged next to one another transversely with respect to the connecting parts in each case two elastomer bodies are connected in parallel and two elastomer bodies are connected in series.

7. The sprung stem according to claim 1, wherein a normal position is provided, in which the coupling apparatus assumes a position, without an external force acting on it, and/or in that the coupling apparatus is configured to be deflected in the two rotational directions about the pivot pins, in order to provide a positive and a negative spring travel.

8. The sprung stem according to claim 1, further comprising a stop element is on the fastening device and/or on the handlebar holder, against which stop element the connecting parts can bear in each case during rotation about the pivot pin, and a further continuation of the rotation is thus prevented, wherein the at least one stop element:
is configured as an elastomer, and/or
is attached between the two pivot pins to the fastening device and/or between the two pivot pins to the handlebar holder.

9. The sprung stem according to claim 1, wherein the at least one elastomer body has a change in cross section in a cross section along a plane which runs parallel to the pivot pins, and/or parallel to the spacer elements, wherein:
there is the greatest contact area between the respective elastomer body and the spacer element in the center of the respective elastomer body, and/or
the contact area between the respective elastomer body and the spacer element increases toward the center of the respective elastomer body disproportionately with a displacement of the spacer element toward the center of the elastomer body, and/or
the at least one elastomer body has an X-shape and/or the shape of an hourglass and/or the shape of two wedges, the tips of which face one another, in cross section along a plane which runs parallel to the pivot pins.

10. The sprung stem according to claim 1, wherein the elastomer body and/or a single one of the elastomer bodies is penetrated by the respective connecting lines between the fastening device and the handlebar holder, which connecting lines perpendicularly intersect the respective two pivot pins which lie opposite one another, wherein the elastomer body is configured and arranged in such a way that it is smaller in the direction of the connecting lines between the pivot pins which lie opposite one another than with regard to its extent between the two shells and/or connecting parts, with the result that the elastomer body is rather sheared than compressed.

11. The sprung stem according to claim 1, wherein the coupling apparatus has precisely one elastomer body for mechanical coupling of the connecting parts.

12. The sprung stem according to claim 1, wherein the at least one elastomer body is configured as a closed ring.

13. The sprung stem according to claim 1, wherein the elastomer body:
is of axially symmetrical configuration with regard to an axis of symmetry which runs parallel to the pivot pins, and/or
the elastomer body has a stepped shape on its outer shell, with the result that two steps which are arranged diagonally with respect to one another in relation to the axis of symmetry are provided, wherein the higher step is situated in each case in the region of the respective other connecting part, and wherein the respective step which is mounted further to the outside from the center of the elastomer body faces in one case the fastening device and in one case the handlebar holder,
wherein the elastomer body is configured with regard to its axial symmetry and/or its stepped shape to orient the parallelogram which is formed in such a way that its interior angles in each case differ from 90°.

14. The sprung stem according to claim 1, wherein the elastomer body has, along its axis of symmetry, a recess which penetrates the elastomer body for receiving mounting shafts and/or for introducing an element for setting the spring hardness, which recess is preferably of slot-shaped configuration.

15. The sprung stem according to claim 1, wherein the elastomer body and/or the recess are/is penetrated by one or more mounting shafts which runs/run parallel to the axis of symmetry, wherein:
the mounting shafts run in one plane, and/or
one of the mounting shafts lies on the axis of symmetry, and/or
one of the mounting shafts comprises a body which is configured as a spring stiffness pin and is mounted such that it can be adjusted in a linear manner, in order for it to be possible for it to be introduced into the elastomer body and moved out again, such that, as a result, the stiffness of the coupling apparatus and/or the sprung stem can be set, and/or
the mounting shafts are connected to one another via at least one connecting web, and/or
the spring stiffness pin has a thread which is in engagement with the thread of an adjusting spindle, in order, as a result, to implement a linear movement in the direction of the elastomer body or away from the elastomer body.
